(19) United States
(12) Patent Application Publication
(10) Pub. No.: US 2007/0133940 A1
(43) Pub. Date: Jun. 14, 2007

(54) System and method for generating and documenting personalized stories

(76) Inventor: Andrew Phillip Freeman, Santa Cruz, CA (US)

Correspondence Address: PATRICK REILLY, BOX 7218, SANTA CRUZ, CA, 95061-7218, US

(21) Appl. No.: 11/301,173

(22) Filed: Dec. 10, 2005

(51) Int. Cl. H04N 5/93

(52) U.S. Cl. 386/52

(57) ABSTRACT

The invention enables customers to generate a story by interaction with a computer. A software program allows the customer to assume the role of a character within a story. Digitized photographs and personal data are captured and input (retail environment) or uploaded (Web environment), relating to the customer, associated children, family members, pets, friends, or acquaintances. During a session the customer makes decisions affecting the storyline and/or story outcome. A representation of the story may be produced with the digitized photographs, names and personal information melded into the representation and/or merged into graphical elements. This personalized story is made available to the customer in physical or electronic form, such as a book, CD, DVD, or videogame. Customers' created content is stored, and is available for viewing in its entirety or as repurposed scenes in various electronic or physical forms, such as in printed or electronic greetings and on various merchandise items.

### FIELD OF THE INVENTION

The present invention relates generally to publishing methods and systems, and more particularly with the generation and publication of documents by interaction of a human with an information technology system.

### BACKGROUND OF THE INVENTION

The process of internalization by a person of the contents of fictions, true stories, histories and mythologies are a great influence on the development of human personality. Human beings construct unifying culture by creating and sharing stories. Our psychologies are geared towards defining group and personal identities as well as the meaning of our lives by contextualizing our inner lives and interaction with society and nature within constructed fictional and non-fictional narratives.

Modern information technology has greatly increased the capability of publishers of either fiction or non-fiction to track the behavior and preferences of a consumer and deduce works of various media types that are likely to appeal to the consumer. It is well known that readers are typically more profoundly affected by stories having one or more characters to which the reader can more closely relate. Yet the prior art offers little access to the general public to the power and flexibility of information technology, and its ancillary arts, to interactively generate a story scenario with a person (hereafter “actor”) and to publish either electronic media or hard copy documents memorializing an interactively generated story scenario.

There is therefore a long felt need to provide publishing methods and tools that more deeply personalize a story to a reader of the story and that more thoroughly memorializes the co-production of a story session by a user interacting with an information technology system. It is the primary object of the Method of the Present Invention to provide methods and tools to support the generation and publication of personalized stories. This and other objects of the invention will become clear from an inspection of the detailed description of the invention and from the appended claims.

### SUMMARY OF THE INVENTION

Towards these objects and other objects that will be made obvious in light of the present disclosure, the Method of the Present Invention provides tools for interactively generating a story scenario within a story session and for publishing a record of the story scenario. In a first preferred embodiment of the Method of the Present Invention, an information technology system is provided with a software program that enables the information technology system (hereafter “actor system”) that enables an actor to make selections that affect the flow and outcome of a story scenario within a story session. One or more records may be made of the interactivity of the actor and the actor system in various alternate preferred embodiments of the method of the Present Invention, to include an electronic media record, one or more published hard copy sheets, a hard copy card configured for delivery by a postal service, a bound book, and other suitable publications known in the art.

In a second preferred alternate embodiment of the Method of the Present Invention, the actor may optionally input textual, audio, graphic, and/or photographic content into a digitized record of a story scenario stored on electronic media.

The foregoing and other objects, features and advantages will be apparent from the following description of the preferred embodiment of the invention as illustrated in the accompanying drawings.

### BRIEF DESCRIPTION OF THE DRAWINGS

These, and further features of the invention, may be better understood with reference to the accompanying specification and drawings depicting the preferred embodiment, in which:

FIG. 1 illustrates a plot flow of a story scenario generated within a story session;

FIG. 2 is a flow chart of a software program that instantiates a story session and generates a story scenario;

FIG. 3 is a story experience record generated and updated by the software program of FIG. 2;

FIG. 4 is an actor profile generated and updated by the software program of FIG. 2;

FIG. 5 is dynamic character profile generated and updated by the software program of FIG. 2;

FIG. 6 is an actor play account generated and updated by the software program of FIG. 2;

FIG. 7 is an actor sales account generated and updated by the software program of FIG. 2;

FIG. 8 is a flow chart of a software program that instantiates a sales session and generates and updates a sales account;

FIG. 9 is an informational technology network 2 that executes the software program of FIG. 2;

FIG. 10 is a schematic diagram of the actor system of FIG. 9;

FIG. 11 is a detailed schematic diagram of elements of the actor system of FIG. 9;

FIG. 12 is an illustration of a story station comprising elements of the actor system of FIG. 10 and the informational technology network 2 of FIG. 9;

FIG. 13 presents a visual component V of a scene as stored in a story experience R and generated by the actor system 4 or the publisher system 8;

FIG. 14 is a schematic of a template useful in generating a story line for inclusion in software program of FIG. 1 FIG. 2, and/or FIG. 8;

FIG. 15 is a schematic of a possible modular design of all or part of the software of FIGS. 1, 2 and 8 in singularity or combination; and

FIG. 16 is a schematic of a possible site map of a website W that may be made available to the actor via the actor system, the publisher system, and the digital storage system, and/or the informational technology network of FIG. 9.

### DETAILED DESCRIPTION OF PREFERRED EMBODIMENTS

The following description is provided to enable any person skilled in the art to make and use the invention and sets forth the best modes contemplated by the inventor of carrying out his or her invention. Various modifications, however, will remain readily apparent to those skilled in the art, since the generic principles of the Present Invention have been defined herein.

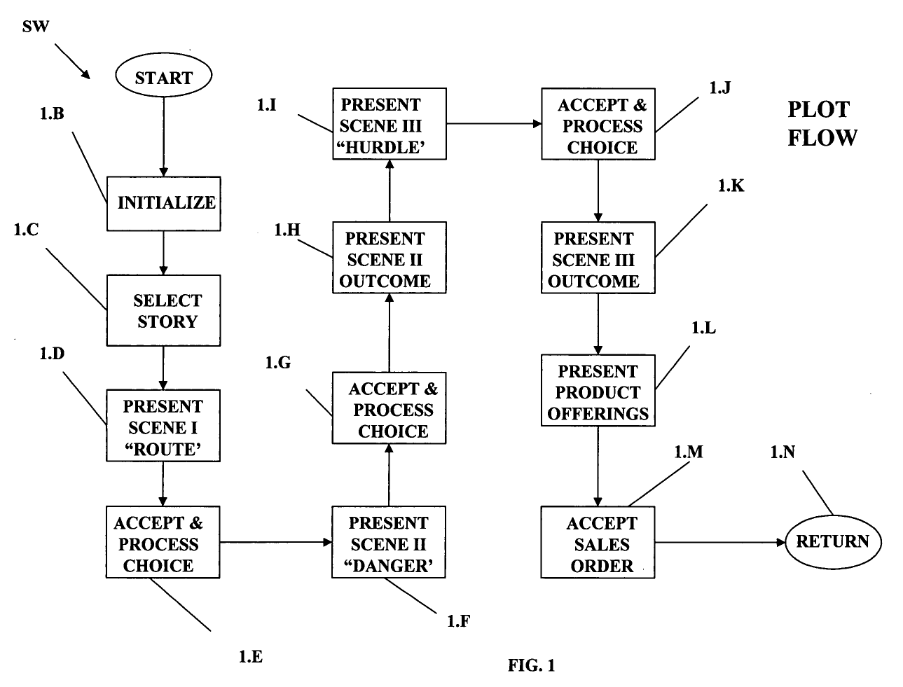

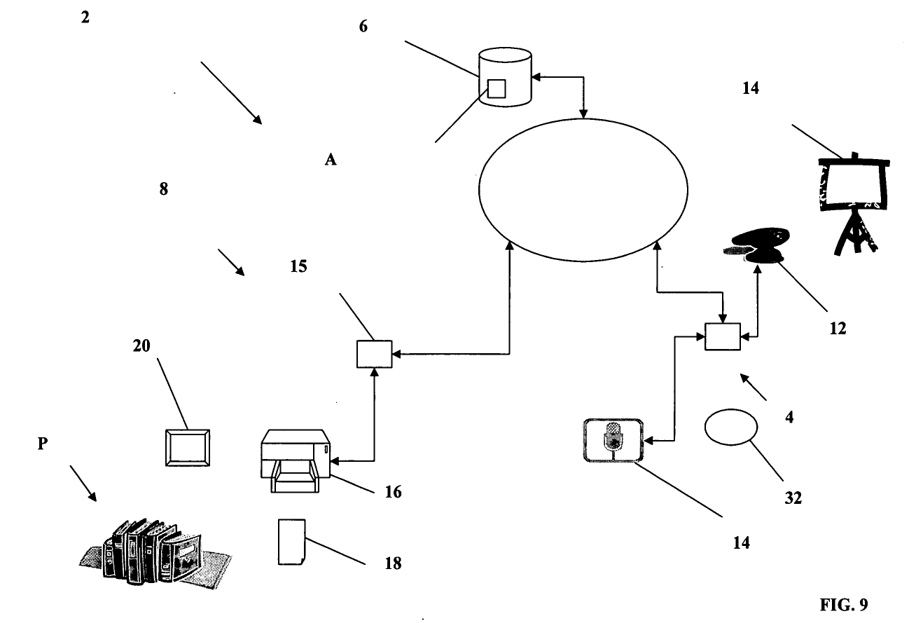

Referring generally to the Figures and particularly to FIG. 1, FIG. 1 illustrates a plot flow of a story scenario generated within a story session. The story session allows the actor to choose a story from a selection of pre-programmed stories. Each story is encoded in computer readable software SW and empowers the user by means of an actor system 4 (as per FIG. 9) to interactively generate a flow of a story scenario within a story session. In execution of the software SW by the actor system 4, after selecting a story in step 1.C the user selects a route option of a scene I in step 1.D as allowed by the story selected in step 1.C. In step 1.E the software program SW accepts a choice made by the actor and then integrates the choice made in step 1.E in a presentation made to the actor in step 1.F. This pattern of scene presentation, choice acceptance and integration, and outcome presentation is repeated in steps 1.I, 1.J and 1.K. The outcome presented in step 1.K comprises an end of the story scenario and a conclusion of the story session. In step 1.L the actor is presented with product offerings that may include a printed card suitable for mail delivery, the generation of a story representation transmittable via an electronic card and/or presented on a hard copy sheet including visually observable textual, graphic, photographic and/or iconic images. In step 1.M the actor may execute a purchase.

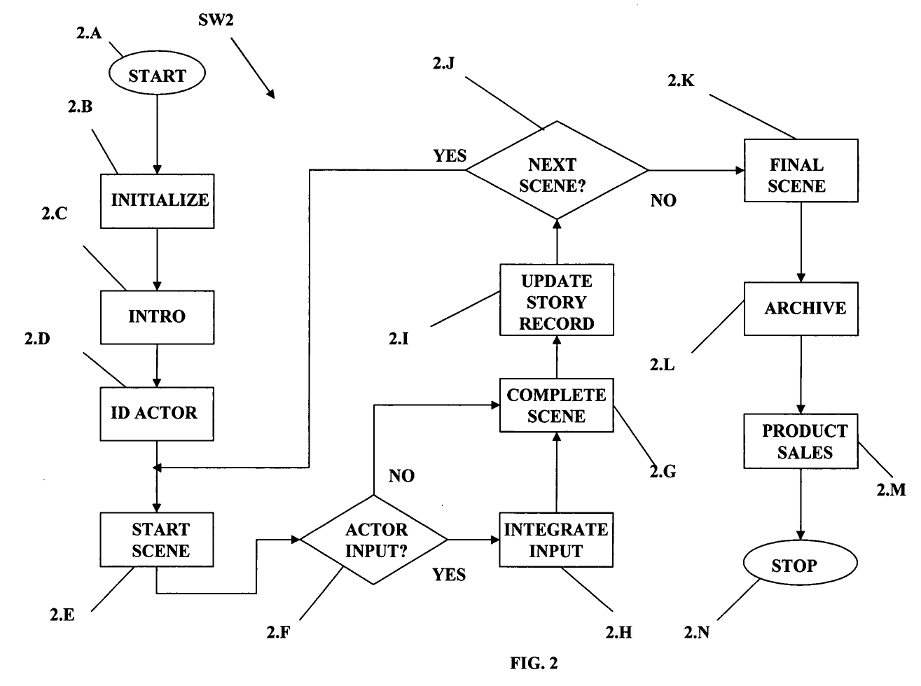

Referring generally to the Figures and particularly to FIG. 2, FIG. 2 is a flow chart of a software program SW2 that instantiates a story session and generates a story scenario by means of execution by the actor system 4. In steps 2.A and 2.B the software SW2 is initialized and an intro presentation is made to the actor via the actor system 4. In step 2.D the actor is identified to the software SW2, whereby a history of the actor's interaction with the software SW2 and actor system 4 may be referenced. In step 2.E a scene is initiated, wherein the actor is prompted to make a choice or otherwise provide an input. The actor may be presented in a scene with a visual and audio output from the actor system 4. The actor's input may be, in exemplary scenes, to select a color, provide a digitized image, or input a name. In certain versions of the software, the actor is prompted to input his or her name by textual means, a vocal input, and a digitized photograph of the face of the actor. In these versions, the textual representation of the name and digitized photograph are integrated in step 2.H into a complete scene that is presented in step 2.G. In these examples, the completed scene might include an illustration with the facial photograph embedded therein, and the name presented in text in a dialog box of a graphic image, as well as an audio presentation component within the scene that includes an audio broadcast of the vocal recording of the actor. In step 2.I a record R of the story is updated and in step 2.J the software determines whether another scene shall be processed through steps 2.E-2.I. The final scene is presented in step 2.K, and the story record R is archived in step 2.L in the actor system 4. The actor, or a third party, is presented with an opportunity to purchased a product derived from the archived story in step 2.M, wherein the products offered for purchase may include a hard copy document or an electronic document capable of transmission via a computer network 2, such as an e-greeting card, an animated feature, or an audio recording.

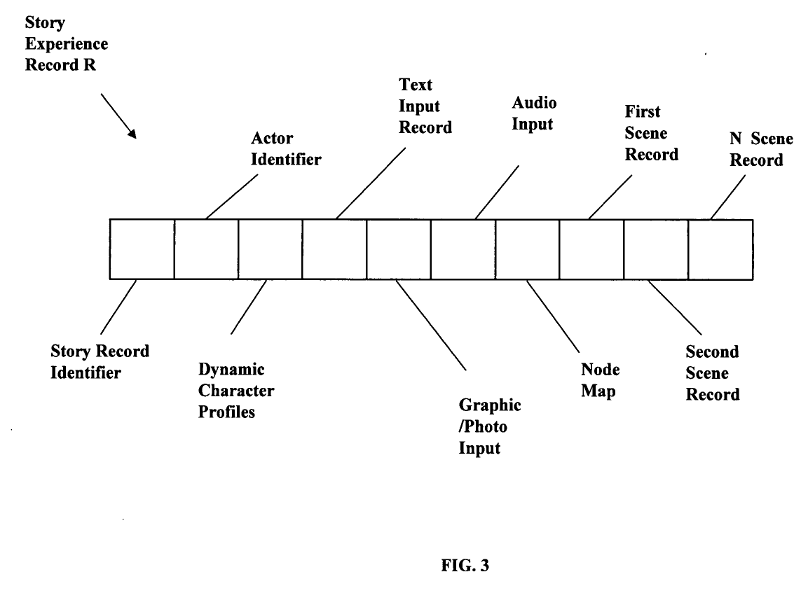

Referring generally to the Figures and particularly to FIG. 3, FIG. 3 is a story experience record R generated and updated by the software program SW2 of FIG. 2. The story experience record R has separate data fields for a story record identifier, an actor identifier, a character profile, a text input record, graphic/photo input, a story line map identifier, and a first story record through an N story record.

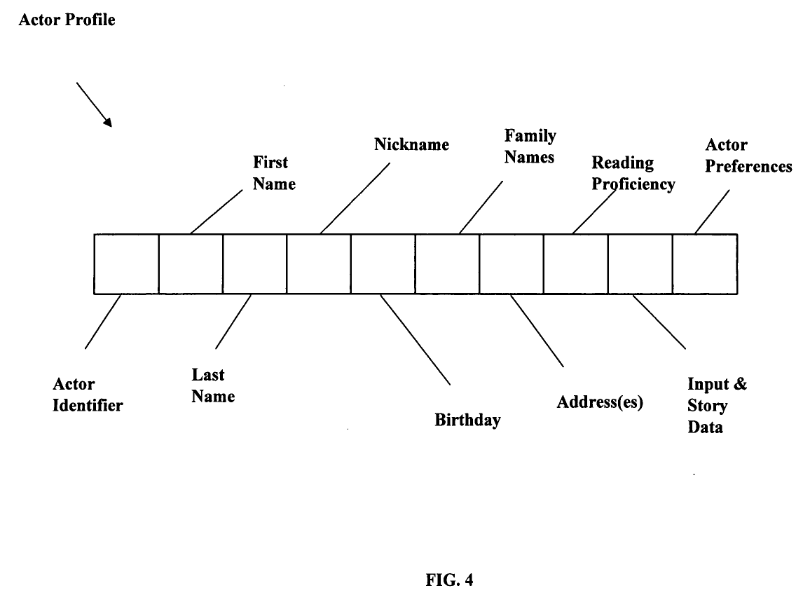

Referring generally to the Figures and particularly to FIG. 4, FIG. 4 is an actor profile generated and updated by the software program SW of FIG. 2. The actor profile includes separate data fields for an actor identifier, a first name of the actor, a last or family name of the actor, a nickname, a birthday date, associated family names, and address book of associated persons and entities, a reading proficiency metric of the actor, previously input textual, graphic and photographic data with story information, and actor preferences.

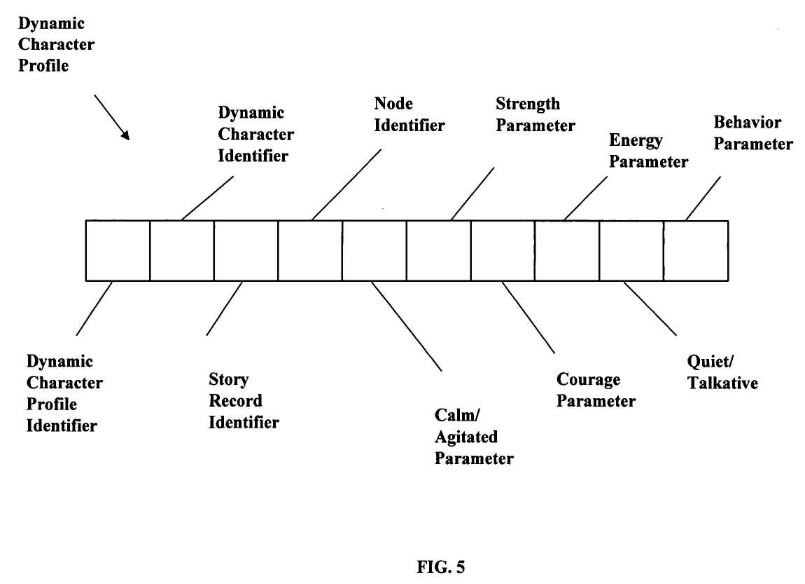

Referring generally to the Figures and particularly to FIG. 5, FIG. 5 is dynamic character profile generated and updated by the software program SW2 of FIG. 2.

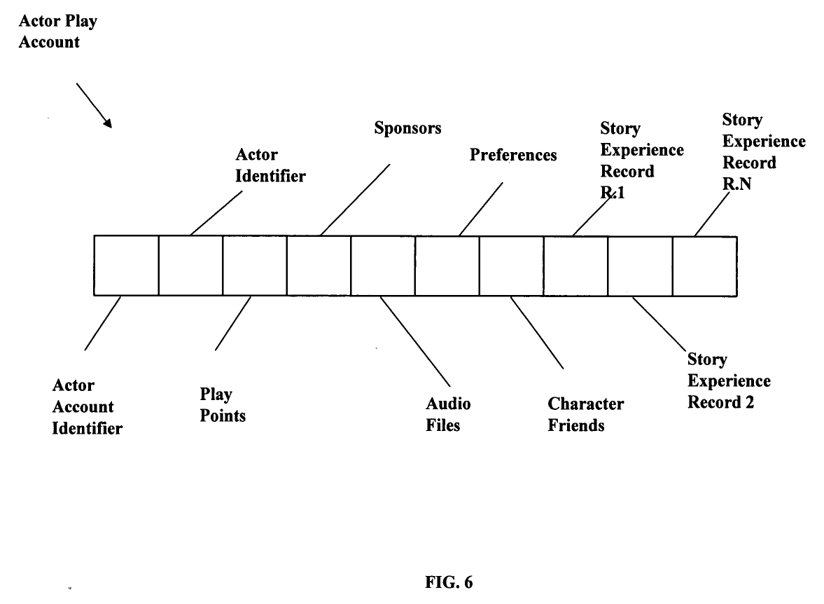

Referring generally to the Figures and particularly to FIG. 6, FIG. 6 is an actor play account generated and updated by the software program SW of FIG. 2.

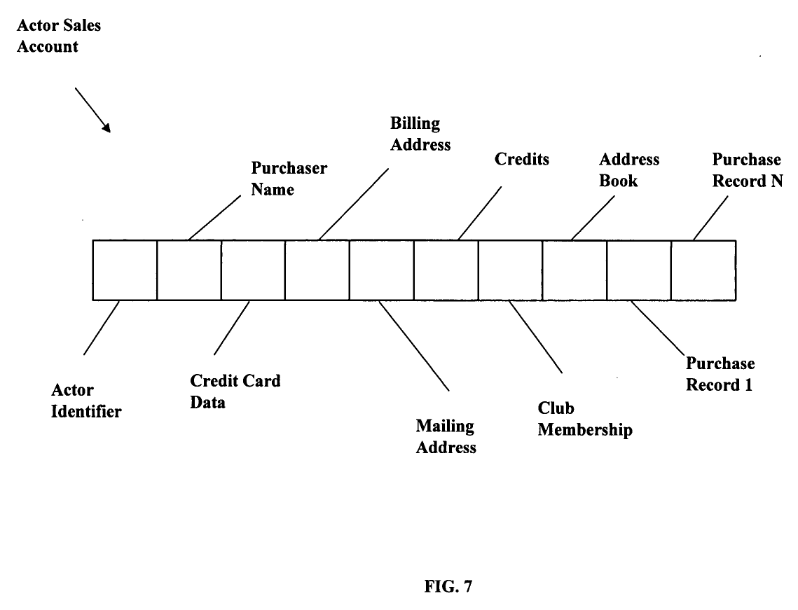

Referring generally to the Figures and particularly to FIG. 7, FIG. 7 is an actor sales account is generated and updated by the software program SW of FIG. 2.

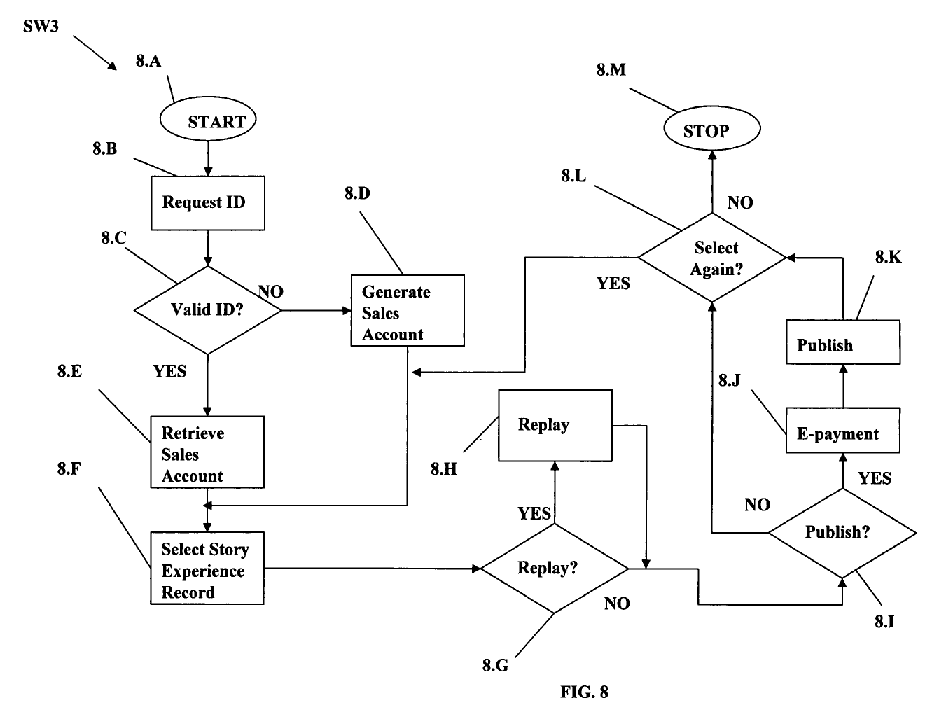

Referring generally to the Figures and particularly to FIG. 8, FIG. 8 is a flow chart of a software program SW3 that instantiates a sales session and generates and updates a sales account. In execution by the actor system 4 or a publisher system 8 step 8.B a potential customer is prompted to provide an identification related to an established sales account (hereafter “valid identification”). In step 8.C the software SW3 determines whether a valid identification has been provided by the potential customer. Where the potential customer fails to provide a valid identification in step 8.B, the software SW3 initiates a step 8.D whereby the customer is enabled to create a new sales account and associate the new sales account with a specified identification, such as a password or information available from a driver's license or other document. Where a valid identification has been provided in step 8.B, the software retrieves an archived sales account associated with an actor identifier indicated by, or provided in, the valid identification in step 8.E. In step 8.F the software SW3 enables the potential customer to select a store experience record R and to, in step 8.G, choose to replay at least some of the story experience record R, as per step 8.H. In step 8.I the potential customer is prompted to request a publication of a product derived from the story experience record R selected in step 8.F. The potential customer thereby becomes an actual customer when opting to make a purchase and executing the electronic payment step 8.J. The software SW3 thereupon directs the publication of a purchased product in step 8.K. The software SW3 enables the actual or potential customer in step 8.L to elect to again select a story experience and cycle through steps 8.F through 8.L.

Referring generally to the Figures and particularly to FIG. 9, FIG. 9 is an informational technology network 2 that executes the software program SW of FIG. 1, the software program SW2 of FIG. 2 and/or the second software program SW3 of FIG. 8. An actor system 4 is communicatively coupled with a digital data storage system 6 and a publisher system 6. The network 2 may be or comprise the Internet or other suitable electronic communications network known in the art.

The actor system 4 includes a video screen 10 for presenting visual images of the story scenes and an audio output device 10 for broadcasting sound components of the story. A digital camera 12 of the actor system captures and digitizes images, such as a head shot of the actor, for integration within illustrations of the story. A green screen 14 provides background for images captured by the digital camera 12, whereby images that include a background generated by means of the green screen 14 may be more effectively integrated into illustrations. A digitizing microphone 14 collects sound inputs from the actor and the real-time environment of the story session, and provides digital audio data derived therefrom to the actor system 4 for integration into the story experience record R. The actor system 4 may transmit a story experience record R of a story session to the digital storage system 6 and/or the publisher system 6 via the network 2.

The publisher system 6 includes a computer 15, a printer 16 and a plurality of hard copy sheets 18, such as greeting card stock or typing paper. A manual binder 20 is used to form multi-sheet products from the sheets and binding material. A variety of products P comprise hard copy greeting cards, books bound by means of the manual binder 20, and other suitable products made from printing data read from a story experience record R onto a hard copy sheet 18 by means of the printer 16.

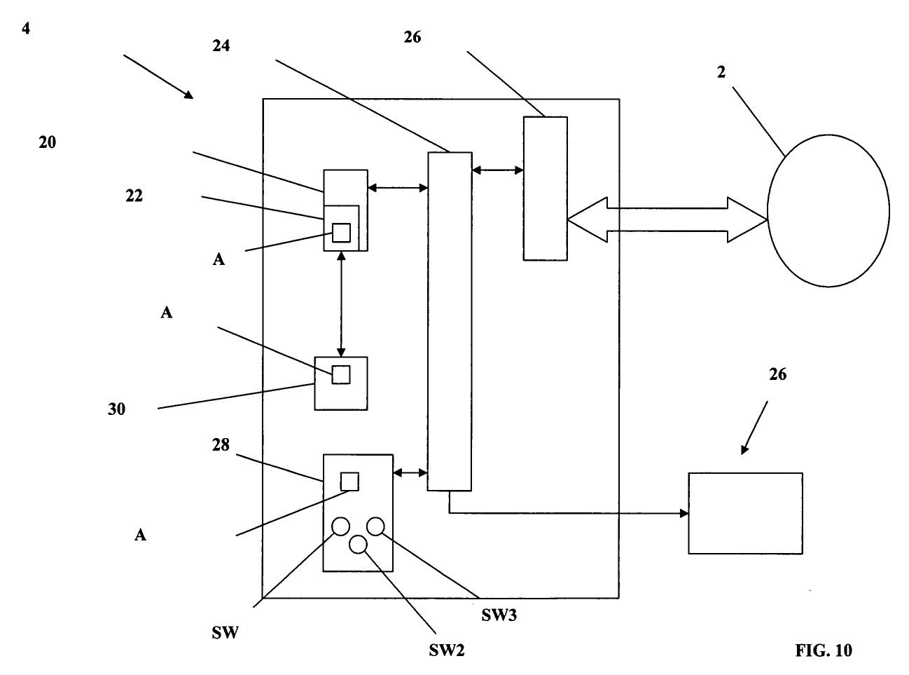

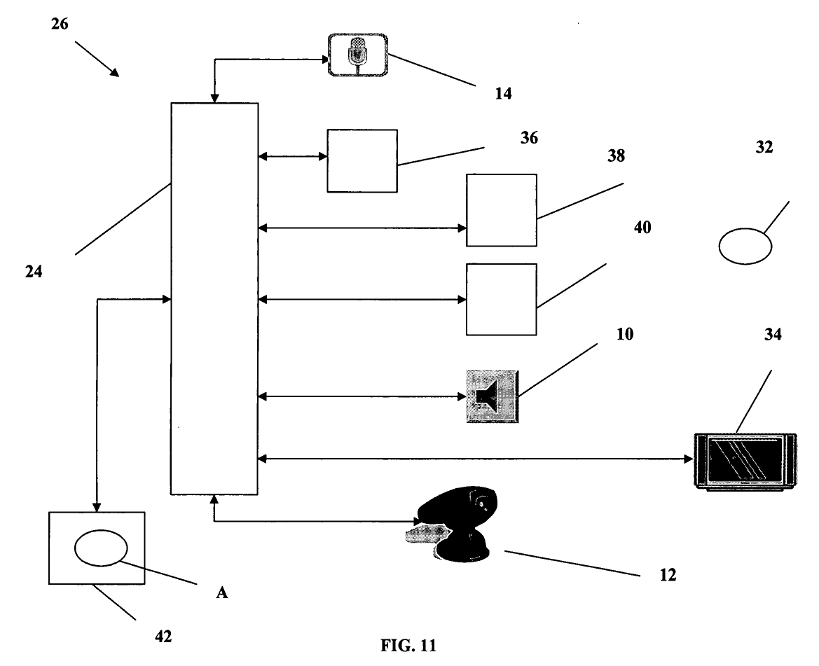

Referring generally to the Figures and particularly to FIG. 10, FIG. 10 is a schematic diagram of the actor system of FIG. 9. A processor 20 includes an on-chip cache memory 22 is coupled by means of an internal bus 24 to a network interface device 26, a main system memory device 28, and a plurality of peripheral devices 26. An off-chip cache memory 30 is directly coupled with the processor. Some or all of an archive A containing a plurality of story experience records R may be contained within and/or distributed among the main memory 26, an electronic media 32 (as per FIGS. 9 and 11), the off-chip cache memory 30 and/or the archive system 6.

Referring generally to the Figures and particularly to FIG. 11, FIG. 11 is a detailed schematic diagram of elements of the actor system of FIG. 9. The peripheral devices 26 coupled with the internal bus 24 of the actor system 4 include the digitizing microphone 14, the audio output device 10, a video display 34, the digital camera 12, and data textual input device 36, a digital data input device 38, and a hard disk drive 40. The digital data input device 38 may be configured to accept digitized textual, audio, photographic and video data from the electronic medium 32. Where the electronic medium 32 is a digital data disk, the hard disk drive 40 is configured to read digitized textual, audio, photographic and video data from the electronic medium. A secondary memory 42 may be used to store some or all of the a story record R or the archive A.

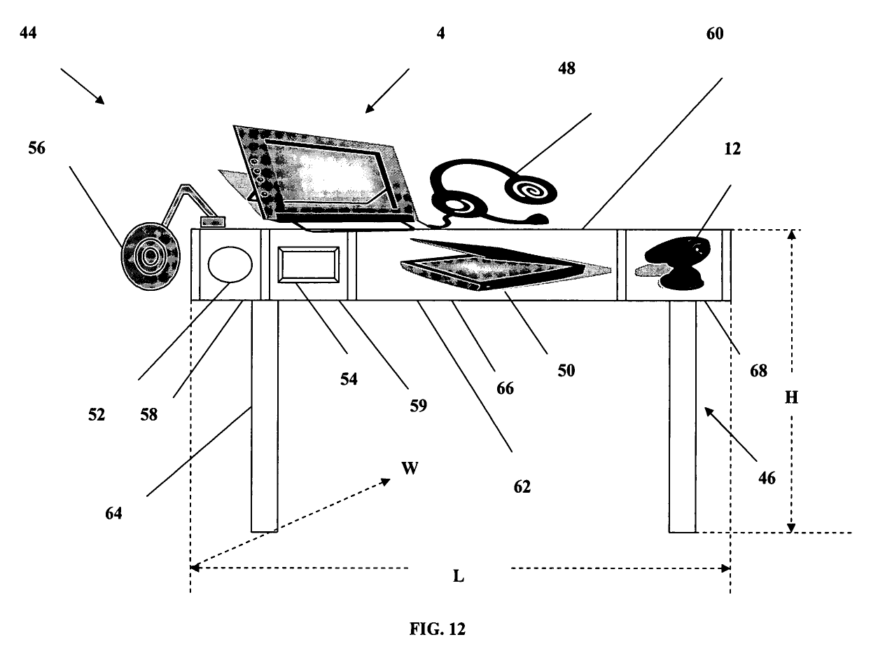

Referring generally to the Figures and particularly to FIG. 12, FIG. 12 is an illustration of a story station 44 comprising elements of the actor system 4 of FIG. 10 and the informational technology network 2 of FIG. 9. The story station 44 includes a table 46 bearing the actor system 4 with an audio headset 48, a digital camera 12, a digitizing scanner 50, a green screen fabric 52 and frame 54, and a lighting device 56. The green screen fabric 52 and the green screen frame 54 are comprised within the green screen 14. The green screen fabric 52 is shown rolled up and placed within an enclosure 58 of the table. The green screen frame 54 is folded into a storage position and placed in a separate enclosure 59. The lighting device 56 is used in conjunction with the green screen 14 to improve the image quality of digital photographs generated by the digital camera 12.

The table 46 has a top surface 60, a body 62 presenting a plurality of enclosures 58, 66 and four legs 64. The legs 64 may be folded up towards the table body 62 for storage and transport. Preferably, the table with the legs supporting the actor system 4 in use with customers is sized to fit within a height H of four feet, a length L of four feet, and a width of W of five feet. The width W is measured along an axis orthogonal to both the L and H axes. The table top 60 is preferably a substantively flat surface and has a cross-sectional area of the width W and length L dimensions of the table 46. The plurality of enclosures 58 are each individually sized and shaped to contain at least one element 4, 48, 12, 50, 52, 54 & 56 of the story station 44.

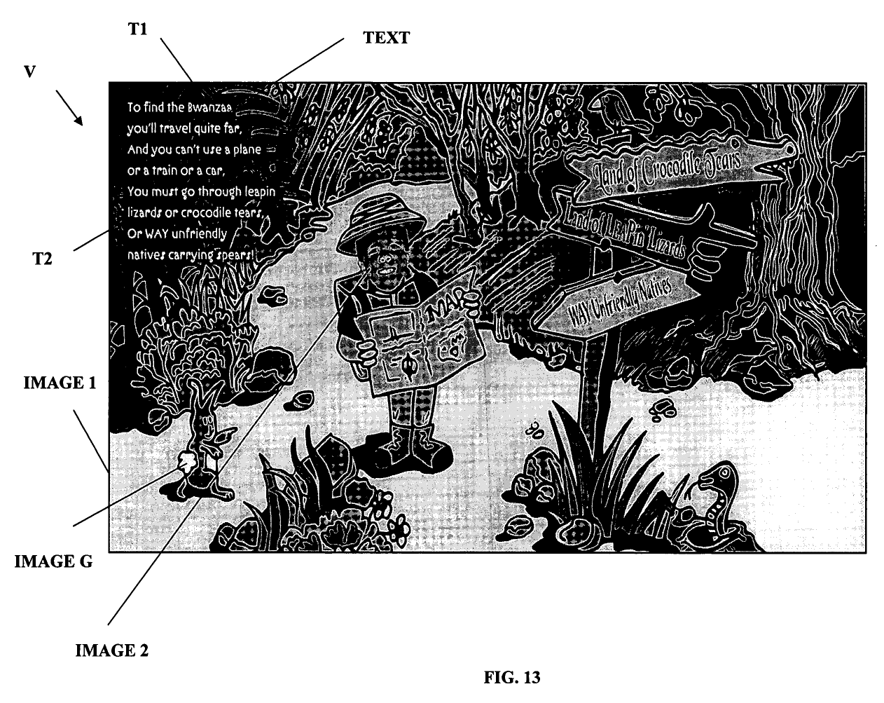

Referring now generally to the Figures and particularly FIG. 13, FIG. 13 presents a visual component V of a scene as stored in a story experience R and generated by the actor system 4 or the publisher system 8. The IMAGE 1 is generated from graphic data provided by a software program SW, SW2, or SW3. The IMAGE 2 is generated from a personal photographic data stored in the Graphic/Photo Input data field of the story experience record R. The personal photographic data may have been generated by the digital camera 12 and/or received by the actor system 4 via the network 2 or provided from the electronic medium 32 via a peripheral device 26 configured to read data from the electronic medium 32 The personal photographic data may have been received by the actor system 4 during the execution of step 2.H of the software SW2, and the graphic data of IMAGE 1 and the personal photographic data of IMAGE 2 may be integrated together in step 2.G of the software SW2, for presentation on the video display 34 of the actor system. The integrated visual image V is then stored in the story experience record R in a scene record data field for later access. The visual image V may include a textual element T that includes story text T1 supplied by the software SW2 and personal text T2 entered by the actor in the execution of step 2.H, and integrated into the visual element V in step 2.G. The personal text T2 may be input to the actor system 4 via the data textual input device 36, or from the electronic medium 32 via the digital data input device 38 or the hard disk drive 40. The visual image V may also include a graphical element IMAGE G generated from personalized graphic data entered by the actor in the execution of step 2.H, and integrated into the visual element V in step 2.G. The IMAGE G may be or comprise an iconic image provided or selected by the actor by means of the software SW or SW and the actor system 4. The personalized graphic data may be input to the actor system 4 via the data textual input device 36, or from the electronic medium via the digital data input device 38 or the hard disk drive 40. The scene comprising the visual image V, and the scene record data field storing the scene, may include additional audio data provided through the microphone 14, or from the electronic medium 32 via the digital data input device 38 or the hard disk drive 40.

The visual image V may provided to the publisher system 8 and therefrom be printed onto a sheet 18 by the printer 16 to produce at least one product P, e.g., a hard copy of a greeting card or a bound story book. Alternatively or additionally, the visual image V may be provided in electronic form and transmitted as an electronic greeting card via the network 2 for display on a computer 15 having a video screen 34 and coupled with the network 2.

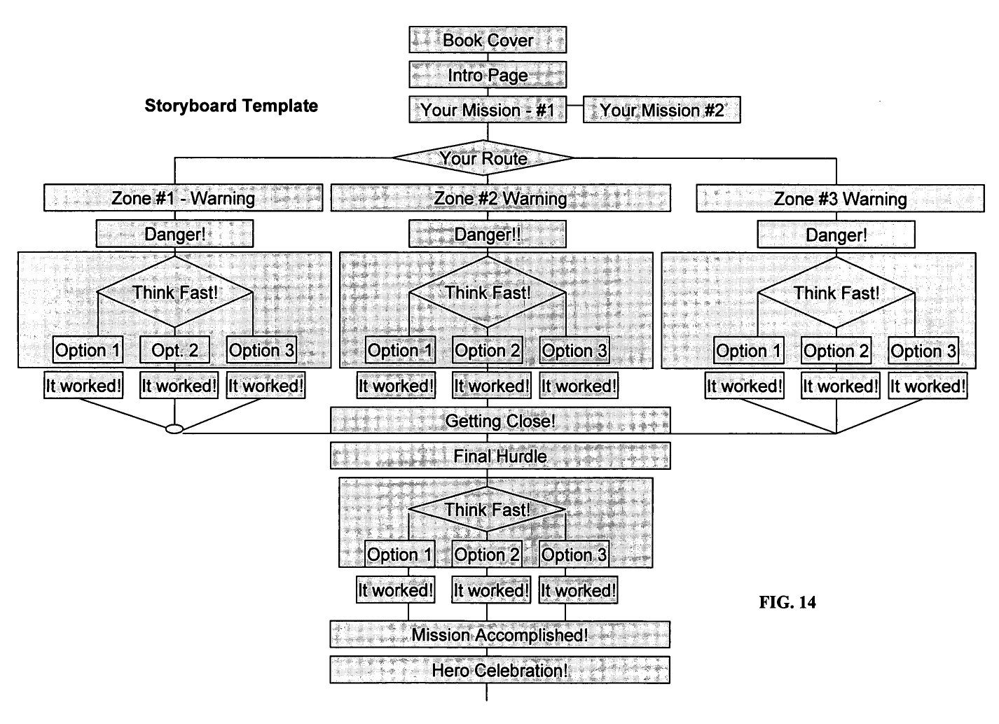

Referring now generally to the Figures, and particularly to FIG. 14, FIG. 14 is a schematic of a template useful in generating a story line. A story line generated in accordance with the template of FIG. 14 may by software encoded in machine-readable code and configured to be comprised within the software SW, SW2 or SW3. The template of FIG. 14 indicates of THINK FAST! decision nodes, from which, in execution of the software SW the software SW2, the actor selects OPTION 1, OPTION 2 or OPTION 3, whereby data is selected from the software SW or SW2 for inclusion in a scene generated and presented via the actor system 4 in, for example, in steps 1.E and 1.F of the software SW, step 2.G of the software SW2.

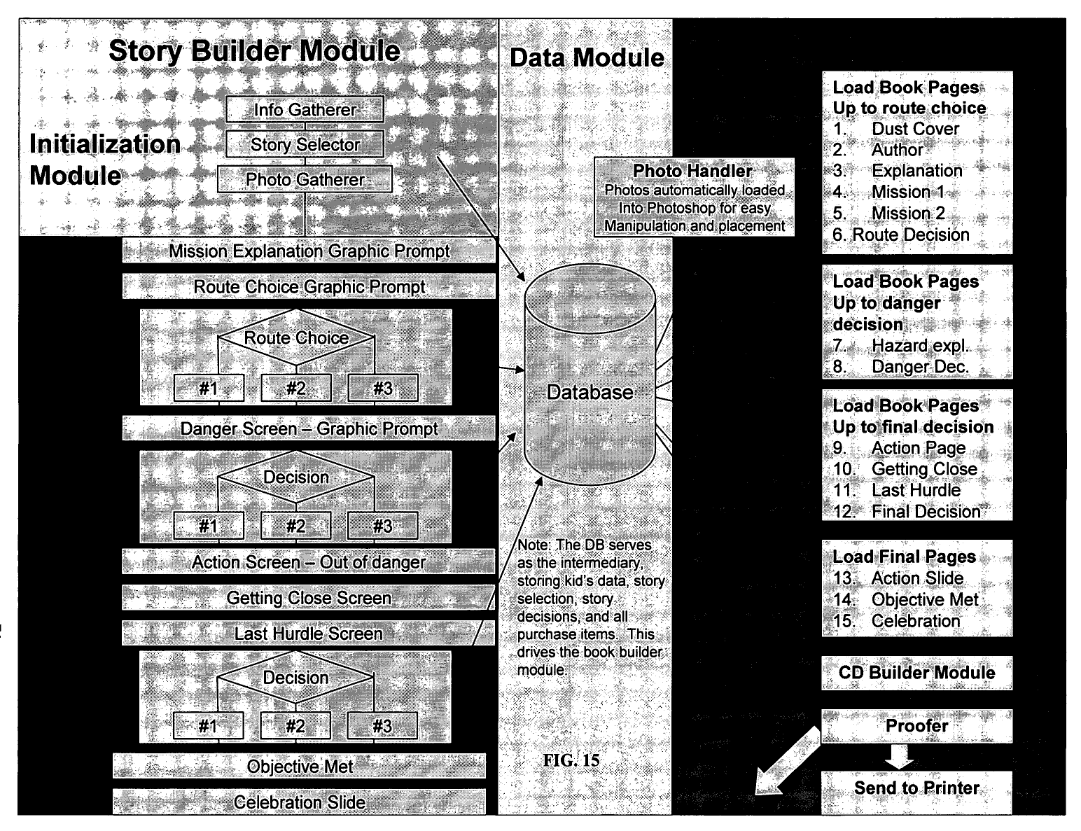

Referring now generally to the Figures, and particularly to FIG. 15, FIG. 15 is a schematic of a possible modular design of the software SW, SW2 and SW3 in singularity or combination. It is understood that modules of the software SW, SW & SW2 may be stored partially or completely in the publisher system 8, the actor system 4, the digital storage system 6, and/or distributed with the network 2.

Referring now generally to the Figures, and particularly to FIG. 16, FIG. 16 is a schematic of a possible site map of a website W that may be made available to the actor via the actor system 4, the publisher system 8, the digital storage system 6, and/or the network 2.

The above description is intended to be illustrative, and not restrictive. Although the examples given include many specificities, they are intended as illustrative of only certain possible embodiments of the invention. The examples given should only be interpreted as illustrations of some of the preferred embodiments of the invention, and the full scope of the invention should be determined by the appended claims and their legal equivalents. Those skilled in the art will appreciate that various adaptations and modifications of the just-described preferred embodiments can be configured without departing from the scope and spirit of the invention. Therefore, it is to be understood that the invention may be practiced other than as specifically described herein. The scope of the invention as disclosed and claimed should, therefore, be determined with reference to the knowledge of one skilled in the art and in light of the disclosures presented above.

1. In an information technology system, a method of enabling interactive generation of a fiction representation, the method comprising:
a. generating a story line comprising a plurality of story elements;
b. at least one story element available for insertion of a personalized information;
c. encoding the story line in machine-readable software; and
d. providing the machine-readable software to the information technology system, whereby a user may make selections and enter personalized data to direct the instantiation of a story line.

2. The method of claim 1, where at least one story element comprises an illustration, and the machine-readable software enables an insertion of a photograph in a publication of the illustration.

3. The method of claim 1, the method further comprising:
a. instantiating a story line in an interactive session of the software with a user;
b. receiving a personalized information from the user; and
c. inserting the personalized information into at least one story element.

4. The method of claim 1, wherein the at least one story element available for insertion of a personalized information is software encoded to accept a representation of a name.

5. The method of claim 1, wherein the at least one story element available for insertion of a personalized information is software encoded to accept a representation of a visual image selected from the group consisting of a photographic image, a graphic image and an iconic image.

6. The method of claim 3, wherein the method further comprises generating a visual representation of the story line by means of a video display of the information technology system.

7. The method of claim 3, wherein the method further comprises generating a visual representation of the story line by means of a video display of an alternate information technology system.

8. The method of claim 3, wherein the method further comprises generating a visual representation of the story line by means of a printer and sheets, wherein the printer creates a visual representation of the story line on a surface of the sheets.

9. The method of claim 8, wherein the sheets are published as a book.

10. The method of claim 8, wherein the sheets are published as a greeting card.

11. The method of claim 3, wherein the method further comprises generating a video game in accordance with the instantiated story line.

12. The method of claim 3, wherein a third party queries the user and the third party provides the personalized information to the information technology system.

13. The method of claim 3, wherein the personalized information is provided to the information technology system via the Internet.

14. The method of claim 3, wherein the personalized information is provided to an additional information technology system via the Internet.

15. The method of claim 3, wherein the instantiated story line is provided to an additional information technology system via the Internet.

16. The method of claim 15, wherein the method further comprises generating a visual representation of the story line by means of the additional information technology system

17. An information technology system, the system comprising:
a. machine-readable instructions, the machine readable instructions for interactively instantiating a story line;
b. means for instantiating the story line;
c. means for querying a user for personalized information and plot decisions;
d. means for accepting personalized information and plot decisions from the user; and
e. means for generating a visual representation of the instantiated story line.

18. The system of claim 17, the means for querying the user comprising a video display.

19. The system of claim 17, the means for generating a visual representation of the instantiated story line comprising a printer and a plurality of sheets, the printer and sheets configured to generate visual images representing the story line on a surface of at least one sheet.

20. The system of claim 17, the means for accepting personalized information and plot decisions from the user comprising an indicated and selected device.

21. A computer-readable medium on which are stored a plurality of computer executable instructions for performing steps (a)-(c), as recited in claim 3.
